(19) United States
(12) Patent Application Publication
(10) Pub. No.: US 2006/0085149 A1
(43) Pub. Date: Apr. 20, 2006

(54) Method and apparatus for computation of electrostatic potential

(75) Inventor: Dage Sundholm, Luoma (FI)

Correspondence Address: MARSHALL, GERSTEIN & BORUN LLP, 233 S. WACKER DRIVE, SUITE 6300, SEARS TOWER, CHICAGO, IL, 60606, US

(73) Assignee: LICENTIA, LTD., Helsinki (FI)

(21) Appl. No.: 11/153,684

(22) Filed: Jun. 15, 2005

Related U.S. Application Data
(60) Provisional application No. 60/580,205, filed on Jun. 16, 2004.

(51) Int. Cl. G06F 19/00

(52) U.S. Cl. 702/65; 702/189

(57) ABSTRACT

A computational method to determine electrostatic interaction by performing direct numerical integration. The method recasts the Poisson equation and approximates the integral by using numerical integration schemes. Multi-dimensional integrals are separated into a coupled product of one-dimensional integrals. Linear transformations are performed and the total electrostatic potential is obtained as a sum of potential contributions for each integration point. The method is computationally efficient and well suited for parallel computers.

### CROSS REFERENCE TO RELATED APPLICATIONS

This application claims priority to U.S. Provisional application Ser. No. 60/580,205, filed Jun. 16, 2004, the disclosure of which is hereby incorporated by reference herein.

### TECHNICAL FIELD

This patent relates generally to molecular modeling and modeling of semiconductor devices. Specifically, the patent relates to the determination of electrostatic potential by using a direct computational approach.

### BACKGROUND OF THE INVENTION

Electrostatic potential in molecular systems is created by the nuclei and the electrons. Chemical reactivity and molecular interactions depend on the electrostatic potential. Electrostatic potentials are of fundamental importance in simulations of charging processes of semiconductor structures and devices. Electrostatic potential is a measurable physical quantity, but it is more commonly obtained in computer simulations. Nuclear contributions to the electrostatic potential can be obtained analytically, whereas calculation of the electronic contribution is more involved as it is created by the static electron distribution rather than by point charges.

Because electrostatic potentials can be obtained analytically only for some simple systems, determination largely relies on numerical methods. Calculation of electrostatic potentials is straightforward, since electrostatic potentials-are generated as the integral of the reciprocal interparticle distance, |r₁-r₂|, times a general charge distribution. Newtonian gravitational potentials may be obtained using similar expressions as used in the calculation of electrostatic potentials.

Such a direct approach has seldom been used as it is considered to be very complicated and time consuming due to the potential involving a six-dimensional space with singularities at r₁=r₂. The preferred method of solving for the electrostatic potentials is to numerically solve the Poisson equation in three dimensions. The Poisson equation is a second-order elliptical partial differential equation describing the electrostatic potential caused by a fixed charge distribution. In three dimensions, the Poisson equation is shown as:
∇₁²φ(x₁, y₁, z₁)=−4πρ(x₁, y₁, z₁)

Solving the Poisson equation numerically is a complicated task since it involves large linear matrix equations with crucial system specific boundary conditions. Because of its importance, much effort in the scientific community has been dedicated towards developing efficient methods of solving the Poisson equation.

Other approaches have been useful for obtaining the electrostatic potential; however, these methods often provide qualitative rather than quantitative accuracy. Several numerical methods of determining the electrostatic potential in chemical and biological systems have been developed in computer programs such as, APBS, DelPhi, ITPACT and Manifold Code.

Equally important applications of Poisson solvers are real space computational methods for electronic structure, the electrostatic potentials caused by the electrons are determined with high accuracy using the Poisson equation. However, this is one of the most time consuming steps in real space computations.

Electrostatic potential is also of great importance in studies of semiconductor devices. Solutions to the Poisson equation for semiconductor structures and quantum dots provide information about their properties and physical insights into the single electron charging processes.

What is needed is a technique that accurately determines electrostatic potential for complex molecular and semiconductor systems.

### SUMMARY OF THE DISCLOSURE

A method for solving differential equations for electrostatic potential is presented, in which the electrostatic potential may be estimated in a system without knowing boundary conditions. The method includes separating a multi-dimensional integral into a coupled product of multiple one dimensional (1D) integrals by applying an integral transformation and using numerical tensorial basis functions, and constructing matrices containing one-dimensional auxiliary integrals for each dimension. Further, the method approximates the auxiliary integral of the integral transformation by using numerical quadrature. Matrix multiplications are performed for each dimension and for each integration point in an auxiliary dimension. The differential contributions are numerically integrated to obtain the electrostatic potential for the system.

A computer system is described that executes a software program in estimating the electrostatic potential for the system. The computer system includes a processor, a memory and a program stored in the memory and executable by the processor. The program incorporates the logic described above in estimating the electrostatic potential.

The described embodiments solve the Poisson equation to computationally estimate the electrostatic potential.

### BRIEF DESCRIPTION OF THE DRAWINGS

FIG. 1 depicts a logic diagram consistent with the teachings of the disclosure.

FIG. 2 is a schematic diagram of a system capable of performing computations in accordance with the logic diagram of FIG. 1.

### DETAILED DESCRIPTION

The described embodiments recast an equation for calculating electrostatic potential into a more usable format and incorporate this equation into a computer software program. The electrostatic potential is defined as an integrated average of a charge distribution multiplied by a reciprocal distance between a position of a charge causing the potential and a potential coordinate. Mathematically expressed as:

$$ϕ ( {x}_{1} , {y}_{1} , {z}_{1} ) = {\int }_{- ∞}^{∞} {\int }_{- ∞}^{∞} {\int }_{- ∞}^{∞} \frac{1}{{r}_{12}} ρ ( {x}_{2} , {y}_{2} , {z}_{2} ) ⅆ {x}_{2} ⅆ {y}_{2} ⅆ {z}_{2} \qquad ( 1 )$$

where ρ(x₂ , y₂, z₂ ) is a charge density,

$${r}_{12} = \vert {r}_{1} - {r}_{2} \vert = \sqrt{{( {x}_{1} - {x}_{2} )}^{2} + {( {y}_{1} - {y}_{2} )}^{2} + {( {z}_{1} - {z}_{2} )}^{2}}$$

is a distance, and φ(x₁, y₁, z₁) is the electrostatic potential. Thus, determination of φ(x₁, y₁, z₁) using Eq. (1) involves six spatial dimensions e.g. (x₁, y₁, z₁) and (x₂ , y₂, z₂), and a singular function, because r₁₂ appears in the denominator. Singularities may be removed; by applying an integral transformation to recast the mathematical expression.

$${\int }_{- ∞}^{∞} \frac{1}{{r}_{12}} ρ ( {x}_{2} , {y}_{2} , {z}_{2} ) ⅆ {x}_{2} ⅆ {y}_{2} ⅆ {z}_{2} = \frac{2}{\sqrt{π}} {\int }_{0}^{∞} {\int }_{- ∞}^{∞} {ⅇ}^{- {{t}^{2} ( {r}_{1} - {r}_{2} )}^{2}} ρ ( {x}_{2} , {y}_{2} , {z}_{2} ) ⅆ {x}_{2} ⅆ {y}_{2} ⅆ {z}_{2} ⅆ t \qquad ( 2 )$$

The integral transformation in Eq. (2) has been used in deriving an efficient recursion relation for the calculation of two electron integrals over Gaussian functions. Next the charge density ρ(x₂, y₂, z₂) may be expanded in a numerical tensorial basis. The tensorial basis consists of basis functions constructed as an outer product of one dimensional basis functions.

$$ρ ( {x}_{2} , {y}_{2} , {z}_{2} ) = {\sum }_{αβγ} {ⅆ}_{αβ γ} {χ}_{α} ( {x}_{2} ) {χ}_{β} ( {y}_{2} ) {χ}_{γ} ( {z}_{2} ) \qquad ( 3 )$$

In the three dimensional case, substitution of the density in Eq. (3) into Eq. (2) yields a separation of a three dimensional integral into a coupled product of three one dimensional integrals. This substitution also derives an expression for calculation of a potential φ(x₁, y₁, z₁) at selected points in space. Coordinates of the chosen potential points are shown in the exponent of the Gaussian function; the one dimensional integrals involving the Gaussian function times the basis function have to be calculated analytically or numerically for each potential point and basis function yielding a computational scaling that is proportional to Nₓ²+N_{y}²+N_{z}², where Nₓ, N_{y}, and N_{z} are the number of grid points in each dimension. Integration in the t direction may be performed numerically using Gaussian quadrature. Thus, an expression for the calculation of the potential in points (x₁, y₁, z₁) may be written as:

$$ϕ ( {x}_{1} , {y}_{1} , {z}_{1} ) = \frac{2}{\sqrt{π}} {\sum }_{{α}_{t}} {w}_{{α}_{t}} {\sum }_{αβγ} {ⅆ}_{αβγ} {\int }_{- ∞}^{∞} {ⅇ}^{- {{t}_{{α}_{t}}^{2} ( {x}_{1} - {x}_{2} )}^{2}} {χ}_{α} ( {x}_{2} ) {\int }_{- ∞}^{∞} {ⅇ}^{- {{t}_{{α}_{t}}^{2} ( {y}_{1} - {y}_{2} )}^{2}} {χ}_{β} ( {y}_{2} ) {\int }_{- ∞}^{∞} {ⅇ}^{- {{t}_{{α}_{t}}^{2} ( {z}_{1} - {z}_{2} )}^{2}} {χ}_{γ} ( {z}_{2} ) ⅆ {x}_{2} ⅆ {y}_{2} ⅆ {z}_{2} \qquad ( 4 )$$

where integration points t_{α}_{ₜ} and corresponding weights w_{α}_{ₜ} have been introduced. The weights w_{α}_{ₜ} are integration weights of the Gauss integration. Other numerical schemes may yield other weight factors. By denoting the integrals of the Gaussian function times the basis function χ_{γ}_{ₓ} (x₂) for the calculation of the potential in point x_{α}_{ₓ} by

$${F}_{{γ}_{x} {α}_{x}}^{x , {α}_{t}} = {\int }_{- ∞}^{∞} {ⅇ}^{- {{t}_{{α}_{t}}^{2} ( {x}_{{α}_{x}} - {x}_{2} )}^{2}} {χ}_{{γ}_{x}} ( {x}_{2} ) ⅆ {x}_{2} \qquad ( 5 )$$

and similar expressions for the y and z terms, the final expression can be written as

$${v}_{{α}_{x} {α}_{y} {α}_{z}} = \frac{2}{\sqrt{π}} {\sum }_{{α}_{t}} {w}_{{α}_{t}} {\sum }_{{γ}_{z}} {F}_{{γ}_{z} {α}_{z}}^{z , {α}_{t}} {\sum }_{{γ}_{y}} {F}_{{γ}_{y} {α}_{y}}^{y , {α}_{t}} {\sum }_{{γ}_{x}} {F}_{{γ}_{x} {α}_{x}}^{x , {α}_{t}} {ⅆ}_{{γ}_{x} {γ}_{y} {γ}_{z}} \qquad ( 6 )$$

where ν_{α}_{ₓ}_{α}_{_{y}}_{α}_{_{z}} denotes the electrostatic potential values for selected grid points. The evaluation of Eq. (6) includes three coupled matrix multiplications, the matrix size of which are Nₓ×N_{y}, N_{y}×N_{z}, and N_{z}×N_{y}, respectively. Auxiliary integrals in F^{x,α}^{ₜ}, F^{y,α}^{ₜ}, and F^{y,α}^{ₜ}, at can be calculated analytically using error function, but for small t values, the analytical expression suffers from numerical instabilities. However, for small t values the auxiliary integrals can be accurately obtained numerically by using, e.g., Gaussian quadrature. The matrix multiplications in Eq. (6) are performed for each grid point in the remaining direction (i.e. z, y, x) and for each t value. This leads to a computational scaling of

$$( {N}_{x}^{2} {N}_{y} {N}_{z} + {N}_{x} {N}_{y}^{2} {N}_{z} + {N}_{x} {N}_{y} {N}_{z}^{2} ) {N}_{t} or$$

$$3 {N}_{x}^{4} {N}_{t} = 3 {N}^{\frac{4}{3}} {N}_{t} when {N}_{x} = {N}_{y} = {N}_{z}$$

NₓN_{y}N_{z}=N are assumed. Thus, the method scales almost linearly with the total number of grid points as Nₜ is independent of grid size used. Two outer loop indices can be used for the distribution of the computational efforts to the processors of one or more parallel computers. Thus, the increase in speed should be substantially linear because the distributed tasks consist of matrix multiplications with no requirement for communication between the processors.

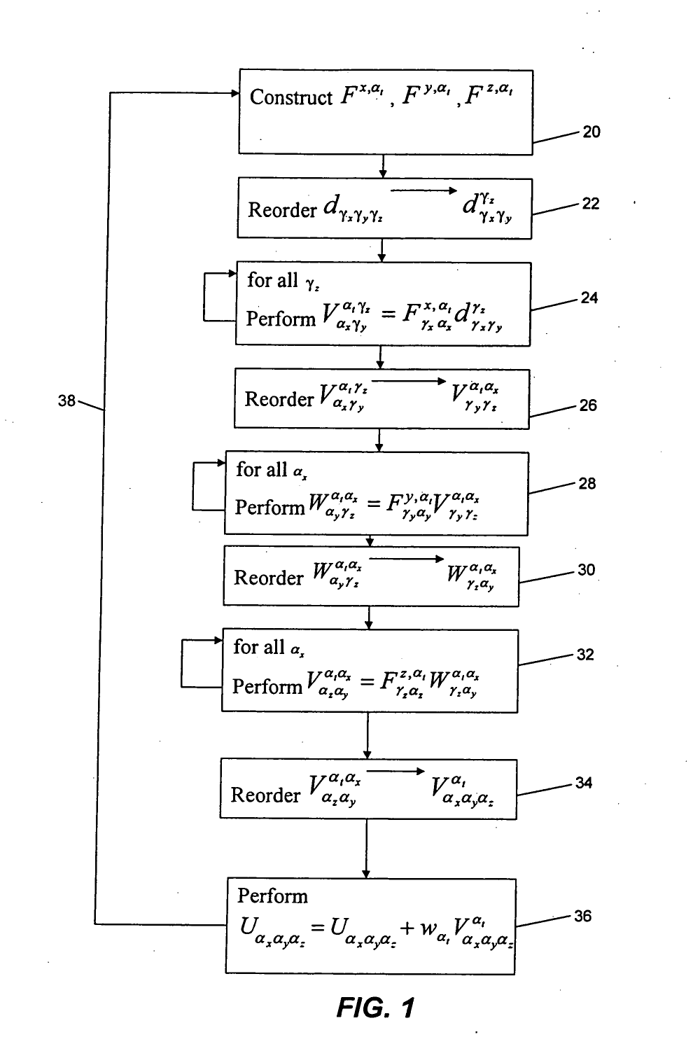

Referring now to FIG. 1. The software implementation of Equation 6 is a series of calculation loops, several smaller loops at 24, 28, and 32 within one larger loop at 38. The number of smaller loops is dependent on the number of dimensions in the system. The larger loop at 38 represents computations for each integration point in the t dimension. In this operation, the Einstein summation convention is used. The Einstein summation convention implies that when an index occurs more than once in the same expression, the expression is implicitly summed over all possible values for the index. The auxiliary integrals are constructed at 20 for each dimension and at each grid point in space. For large t_{α}_{ₜ}, values, the F^{x,α}^{ₜ}, the F^{y,α}^{ₜ} and the F^{z,α}^{ₜ} matrices are band dominant, a property that may be used for acceleration of the computational speed. Linear transformation in the x dimension is performed at 24. The matrix multiplications for the external indices α₁, and y_{z} may be performed on one or more parallel processors, thus accelerating computational speed.

An optional reorder function is performed at 22; this function reorganizes the data into a more rapidly accessible form. This reorder function is introduced to make the matrix multiplications as fast as possible, any other manner of reordering the terms or no reordering at all would be acceptable. Additional optional reorder functions at 26, 30 and 34 similarly reorganize the data.

Linear transformation in the y dimension is performed at 28. In this operation, the Einstein summation convention is used again. The αₜ, and αₓ indices are external indices and the corresponding matrix multiplications may be performed on one or more parallel processors. Linear transformation in the z dimension is performed at 32. In this operation, the Einstein summation convention is also used. The αₜ and αₓ are external indices and the corresponding matrix multiplications may be performed on one or more parallel processors.

Contributions to the electrostatic potential for each integration point in the t dimension are multiplied by the integration weight factor and added to obtain the total electrostatic potential at 36.

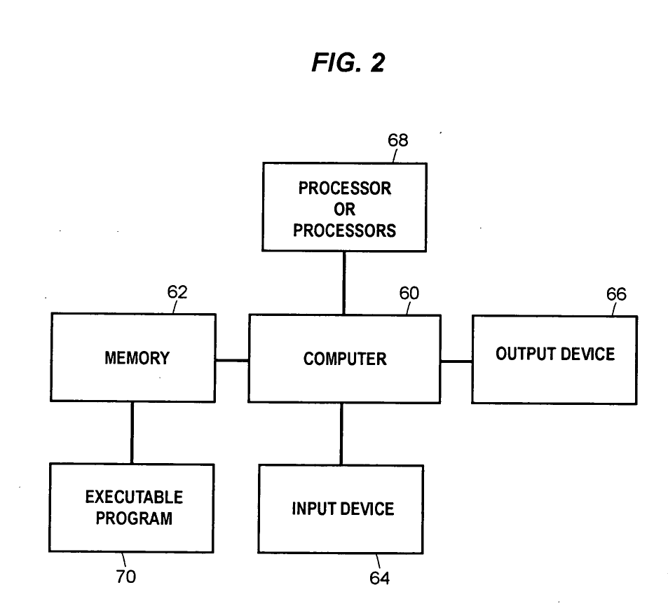

FIG. 2 is a schematic diagram of one embodiment of a computer system used to calculate electrostatic potential. The computer 60 is operatively connected to one or more processors 68, a memory 62, an output device 66 and an input device 64. An executable program 70 is stored in the memory 62 and accessible by the computer 60. The executable program 70 may use the logic described in FIG. 1. The executable program 70 calculates, in the spatial grid points, the contribution to the electrostatic potential of each t_{α}_{ₜ} value and these contributions are summed to obtain the total electrostatic potential for the system. A notation is used wherein matrix elements with increasing first lower indices lie subsequently in the computer memory 62, thus allowing the computer 60 to keep the values as long as necessary and possible in the cache memory, yielding an accelerated computational speed. The computer 60 may divide the matrix multiplications for the outer indices αₜ and γ_{z} at 24 and for the outer indices at and ax at 28 and 32 between the processors 68, thereby accelerating the computational process.

In one embodiment, a tensorial product of Lagrange interpolation functions may be used as a basis function. In this numerical representation, expansion coefficients of the functions are amplitudes of the functions in the grid points. Element functions of arbitrary order may be employed; however, in the described embodiment, second, fourth and sixth order Lagrange interpolation functions have been used. Other kinds of local basis functions, such as, for example, wavelets, splines or any other basis set which can be expressed as a tensor product of the one-dimensional (1D) basis functions may be used. One benefit of this embodiment is that in solving more complicated systems, where higher-order element functions result in more accurate potentials, the higher-order element functions may be performed with almost no additional computational costs (i.e., without slowing down the program).

The described embodiments are directed at solving the Poisson equation in three dimensions. The disclosure could be adapted in other embodiments to solve the Poisson equation in any number of dimensions as well as solving other types of nonlinear Poisson-Boltzmann equations and other related differential equations such as, for example, Schrödinger equations. In the case of non-linear differential equations, the method may be used iteratively to obtain a solution. For example, in the case of the Schrödinger equation, the method begins with an arbitrary initial guess for wavefunction and energy. Integration. may be performed and new energy values used in a subsequent integrations. The process may be repeated until the energy value converges. One skilled in the art will realize the wide range of equations that may be solved by various implementations of the disclosure.

What is claimed is:

1. A method for calculating electrostatic potential comprising:
separating a multi-dimensional integral into a coupled product of multiple one dimensional (1D) integrals by applying an integral transformation and using numerical tensorial basis functions;
constructing matrices containing one-dimensional auxiliary integrals for each dimension;
approximating the auxiliary integral of the integral transformation by using numerical quadrature;
performing matrix multiplications for each dimension;
performing matrix multiplications for each integration point in an auxiliary dimension; and
calculating the electrostatic potential by numerically integrating differential contributions to the electrostatic potential.

2. The method according to claim 1, wherein the differential equation is a Poisson equation.

3. The method according to claim 1, wherein the method is used iteratively and the differential equation is a non-linear Poisson-Boltzmann equation.

4. The method according to claim 1, wherein the method is used iteratively and the differential equation is a Schrödinger equation.

5. The method according to claim 1, wherein the separation of each multi-dimensional integral is accomplished by using Lagrange interpolation functions as the numerical tensorial basis functions.

6. The method according to claim 1, wherein the separation of each multi-dimensional integral is accomplished using wavelets as the numerical tensorial basis functions.

7. The method according to claim 1, wherein the separation of each multi-dimensional integral is accomplished using splines as the numerical tensorial basis functions.

8. The method according to claim 1, wherein the separation of each multi-dimensional integral is accomplished using a basis set expressed as a tensor product of the one dimensional basis functions.

9. The method according to claim 1, wherein the matrix multiplications contain at least one external index and at least three internal indices.

10. The method according to claim 9, wherein the matrix multiplications for each external index are carried out using one of a single processor, parallel processors, or different processors.

11. The method according to claim 9, wherein differential equation is at least a three dimensional differential equation.

12. The method according to claim 11, wherein the matrix multiplications for the external indices are carried out by at least two different parallel processors.

13. The method according to claim 1, wherein the method solves for electrostatic potential in one of chemical, biological or semiconductor systems.

14. A computer system comprising;
a processor;
a memory coupled to the processor;
an executable program stored within the memory, the program being executable by the processor,
wherein the program redefines a differential equation as an integral expression, separates the integral expression into a coupled product of multiple one dimensional integral expressions, constructs matrices containing one-dimensional auxiliary integral expressions for each dimension, approximates the auxiliary integral expression of the integral transformation by using numerical quadrature, performs matrix multiplications for each dimension, performs matrix multiplications for each integration point in the auxiliary dimension, and numerically integrates the differential contributions to the electrostatic potential in the auxiliary dimension.

15. A computer system according to claim 14, wherein the executable program numerically calculates the electrostatic potential according to the following equation:
$${v}_{{α}_{x} {α}_{y} {α}_{z}} = \frac{2}{\sqrt{π}} {\sum }_{{α}_{t}} {w}_{{α}_{t}} {\sum }_{{γ}_{z}} {F}_{{γ}_{z} {α}_{z}}^{z , {α}_{t}} {\sum }_{{γ}_{y}} {F}_{{γ}_{y} {α}_{y}}^{y , {α}_{t}} {\sum }_{{γ}_{x}} {F}_{{γ}_{x} {α}_{x}}^{x , {α}_{t}} {ⅆ}_{{γ}_{x} {γ}_{y} {γ}_{z}} .$$

16. A computer system according to claim 14, wherein the matrix multiplications for each point in space consist of at least one external index and two internal indices.

17. A computer system according to claim 16, wherein the matrix multiplications are carried out on at least one processor.

18. A computer system according to claim 16, wherein the computer system comprises at least a second processor.

19. A computer system according to claim 16, wherein each matrix multiplication for each external index is carried out by a separate processor.

20. A method for calculating electrostatic potential in molecular and semiconductor systems comprising:
recasting a Poisson equation in the 1/r integral expression;
applying an integral transformation of the 1/r operator;
approximating an auxiliary integral of an integral transformation by using a numerical integration scheme;
spanning a density and a potential in a basis of a tensor product of one-dimensional functions;
separating the integral into a coupled product of one-dimensional integrals;
calculating auxiliary one-dimensional integrals and storing the result in a matrix;
performing linear transformations of expansion coefficients of the density by using the auxiliary integral matrices; and
numerically integrating the differential contributions to the electrostatic potential in the auxiliary dimension.
